(19) United States
(12) Patent Application Publication
(10) Pub. No.: US 2024/0149488 A1
(43) Pub. Date: May 9, 2024

(54) CONSTRUCTION BOARD, METHOD AND APPARATUS FOR MAKING SAME AND USE OF SAME

(71) Applicant: SIEMPELKAMP MASCHINEN-UND ANLAGENBAU GMBH, Krefeld (DE)

(72) Inventors: Bert KEHR; Karsten KORTE; Linus SJOEEBRINK, Krefeld (DE); Sven ZIMMER

(21) Appl. No.: 18/281,682

(22) PCT Filed: Apr. 5, 2022
(86) PCT No.: PCT/EP2022/059000

§ 371 Date: Sep. 12, 2023

(30) Foreign Application Priority Data
Apr. 8, 2021 (DE) 10 2021 001 806.0

(51) Int. Cl. B27N 3/18; B27N 1/00; B27N 3/04

(52) U.S. Cl. CPC B27N 3/18; B27N 1/00; B27N 3/04

(57) ABSTRACT

The invention relates to a method for producing a material panel (10), having at least one layer (15, 16, 17) having at least one natural fibre component (F), at least one of the at least one layer (15, 16, 17) comprising a useful product (11) which is produced from a raw material (14) obtained from a preformed material panel (10′). The method has at least one forming process part (BP) and an auxiliary process part (UP) and comprises at least the following steps: i) mechanically contacting pre-crushing of the preformed CD material panel (10′) into raw material (14), ii) decomposition of the raw material, under the action of a pressure shock wave (W) having a pulse duration (ID) and a pulse frequency (IF), into at least a first component (K1) and a second component (K2), at least one of the components (K1, K2) as useful product (11) being suitable for use in the at least one forming process part (BP) for the material panel (10) to be produced, iii) separating at least the second component (K2) and the first component (K1), iv) at least proportionately feeding the at least one component (K1, K2), which is suitable for the forming process part (BP) for the material panel (10), into the forming process part (BP) of the further production process. The invention further relates to an apparatus for producing a material panel having at least one laver, a material panel, and the use of a material panel.

The invention relates to a method of making a construction board having at least one layer having at least one natural-based fiber portion, and where at least one of the layers is comprised of starting material made from raw material derived from a partially preformed construction board.

The invention further relates to an apparatus for making a construction board having at least one layer having at least one natural-based fiber portion, where at least one layer is comprised of a starting material made from a raw material obtained from an at least partially preformed construction board.

The invention further relates to a construction board, and to the use of a construction board for residential construction in particular indoors or in furniture.

The manufacture of construction boards takes place either in steps or continuously. In the case of a stepwise manufacture, the construction boards are made as flat objects with finite dimensions in three dimensions, while the construction boards made in a continuous process are cut from a continuous web having final dimensions only in two spatial directions. In this case, the operation of the joining and/or pressing unit determines whether the overall process is described as a stepped or continuous method. Since in the pressing units, or the combined joining and compacting units, in general, board manufacture is also carried out with appreciable pressures, these units are generally referred to by a person skilled in the art with reference to a total installation as a “press part.” In the manufacture of construction boards for example the working pressures are dependent on the material and size of the construction board to be made, usually in ranges between approximately 50 N/cm² and ca 500 N/cm² and there advantageously between 100 N/cm² and 400 N/cm².

Both in economic terms, as with regard to their technical use, a construction board having at least one layer of starting material having a natural-based fiber portion has a particular point value. Within the meaning of the present specification, natural-based fibers or fiber portions are understood to mean fibers and fiber portions having a natural origin, that is to say derived from an annual or perennial plant, irrespective of whether the fibers or fiber fractions are, for example, pure fibers for the manufacture of MDF/HDF boards or their layer types, or form components of chips, elongated chips or wafers that are typically used for the manufacture of chip or OSB boards or their layer types. The term “wood particles” also used in the following therefore always contains at least some natural-based fibers or fiber components.

Such construction boards are frequently also referred to by a person skilled in the art simply “wood construction boards” even if they have one or more layers which are not based on a raw material obtained from an annual plant. Even construction boards which comprise only one or more layers consisting at least in part of fibers and/or fiber components obtained from annual plants are usually used. Wood construction boards and only extremely rarely are referred to as fiber or grass construction boards.

Such wood construction boards are made in a wide variety of embodiments for different applications. Chipboard, OSB and MDF or HDF boards, as well as hybrid boards constructed from individual layers of such composites, are particularly widespread. The naming of the construction boards depends on the shape and size of the wood particles used for making board or its layers. A person skilled in the art uses “chip board” when it is made from “fine wood particles,” and an “OSB board” when it is made from coarse wood particles. Fine wood particles are generally understood by a person skilled in the art to mean particles whose biggest dimension in a spatial direction does not exceed 60 mm. Usually, these particles are referred to chips and are even designed with a maximum extension of at most 25 mm or even 20 mm. Coarse wood particles are generally understood by a person skilled in the art to mean particles whose biggest dimension in a spatial direction is at least 60 mm. In most cases, these particles described as long chips are even designed with a maximum size of at most 60 mm to 185 mm, in particular of 80 mm to 140 mm.

In contrast, MDF and HDF boards, or the individual layers thereof, are formed from (medium- or high-density compressed) fibers, are usually made with the interposition of a chemical process, usually a type of heating process, and are made of raw materials.

Hybrid boards consist of a plurality of layers of different types and are often particularly suitable if the construction board has to meet different requirements for its intended use.

Such construction boards are then also referred to as wood construction boards if they comprise individual layers which do not have any natural-based fibers and/or fiber components. These are usually laminated construction boards, that is to say wood construction boards laminated on one or on both faces. Plastic is usually used for lamination. So-called coated-chip boards are particularly well known.

The types and types of wood construction boards mentioned are thus made from wood particles (chips, long chips or fibers) of different shape and size, and the wood particles are connected by their own adhesion properties and adding a binder (i.e. glue) in the so-called press part of a construction-board manufacturing plant under the action of pressure and temperature.

More recently, it is endeavored to use annual plants, in particular grass-like plants, in addition to the wood materials required for regrowth for the manufacture of construction boards. These annual plants have the great advantage of rapid growth. Thus, its use is particularly gentle with respect to resource use, and can better fit into the environmental awareness that is increasingly being formed worldwide. In addition, the increasing prosperity in many, for example Asian countries, requires supplying a lot of construction boards for residential construction, in particular interior use or also for furniture construction. Since annual plants do not peel, their harvested products first of all form a homogeneous raw material whose fibers are ideal for the manufacture of materials are made by one production process. Thus, it is also known from the prior art to use single-layer or multilayered construction boards whose individual layers consist of annual plants.

However, the processing of annual plants is significantly more complicated than the manufacture of boards based on wood particles. Thus, the high excretion of silicates, which are abrasive in the manufacture process for treating the plants, forms a great impediment. This requires significantly increased expense, in particular with regard to first costs, for example by additional process steps, the reinforcement of certain contact parts and an increased need for replacement parts. In addition, there is the risk of manufacture stoppage. This considerably increases the difficulty manufacture of boards from annual plants. In addition, these points are contrary to the basically existing advantage of lower environmental pollution.

Not least, in particular, the mechanical properties of particle-based (laminated) boards made from annual plants are different from those from products based on wood particles.

These problems impede the development of the construction board in growth markets and thus also slow down the economic growth in the relevant market. On the other hand, even in Asian countries, large forest with an abundance of old-growth trees are often not available everywhere for economical manufacture in sufficient amounts.

Accordingly, it is an object of the invention to provide a method and an apparatus for making a construction board and a construction board that has a low degree of ecological overall load and good mechanical properties.

In relation to a method of the above-described type, the object of the invention is achieved in that the method has at least one forming process portion and an auxiliary process portion and at least the following steps:
i) mechanically precomminuting the at least partially preformed construction board of raw material,
ii) breaking down the raw material under the action of a pressure shock wave having a pulse duration and a pulse frequency into at least one first component and a second component, at least one of the components being suitable as the starting material for use in at least one forming process portion of the construction board to be made,
iii) separating at least the second component and the first component,
iv) at least partially feeding at least one of the components suitable for the forming process portion of the construction board into the forming process portion of the further manufacture process.

Although various approaches are already known from the prior art, even in preformed, or at least partially preformed construction boards wood particles are to be recycled for reuse. However, up to now, all the approaches known to applicant on a combination of the following influences at least largely possible in practical conversion have failed or have only moderate economic success:

Preformed construction boards have, as raw material, in addition to the natural-based fiber components (or simply spoken of the wood particles) that are valuable for reuse, further raw material components unsuitable for reuse with regard to the manufacture of a construction board and, in the event of unintentional use, can somewhat interfere with the manufacture process.

In addition, these raw material portions can be difficult to separate from the natural-based fibrous material portions. Therefore, most recycling methods have so far been known with so-called “wet parts” that are method steps, in which the usable fibers are usually dissolved in highly temperature-controlled liquors or acids from the remaining composite of the raw material using aggressive chemicals. This, of course, contradicts the ecological concept, especially since high energy consumption is also necessary for dissolving and subsequent drying.

Furthermore, such raw material components can also greatly accelerate the wear of an apparatus for making construction boards, for example if there are nails, screws, latches, fittings or similar solid objects.

A partially preformed construction board can be understood to mean a scrap material that is made in the manufacture process of a construction board that, depending on the degree of curing of the board made, is preformed in one piece. Although such scrap material does not entail the same degree of difficulties in process integration, such as the recovery of raw material from a preformed construction board, which, for example, was also already used, but should in principle be taken into account here, even though principally the focus is on the manufacture of raw material into completely preformed construction boards.

The inventors have therefore recognized that, for the provision of an “ecological construction board,” the incorporation of recycling concept only expedient if the disadvantages associated therewith are not at least largely eliminated.

Therefore, it is provided that the raw material contained in a preformed construction board is first comminuted mechanically and, in a subsequent method step, the valuable natural-based fiber is used as a component serving for further use by means of pressure shock waves.

On the one hand, this offers the advantage that wear can be avoided by in the later steps of thee manufacture process. In addition, the fibers do not have to be chemically treated in a complex manner. The fibers, i.e. the starting material, are also not weakened by a wet treatment and thereby reduced in quality. In contrast to a purely mechanically contacting comminution, the fiber components remain stable in themselves and thus retain high quality for further use.

In this case, the mechanical comminution in particular entails the prior-art measures known per se, such as breaking, sawing, splicing, chopping and the like.

It may be of particular advantage if steps i) to iv) are carried out in the same installation. In this way, it is possible to carry out a particularly meaningful implementation of the entire method. In addition, it may be advantageous here that the possibility of repeating a single method step is then made possible particularly well and for example the successive method steps, taking into account current manufacture results, can be matched in detail to one another.

On the other hand, however, it may also be of particular advantage if at least one of steps i) to iv) is carried out in a first plant and at least one of steps i) to iv) in a second plant, or that all the method steps are carried out in an installation including the first factory and the second factory.

This enables a high specialization of the individual plant and can thus lead to a particularly high utilization of the resources.

It may also be advantageous if the preformed construction board is of a particular type and the construction board (to be made) is assigned to another construction board type of if the construction board type of the preformed construction board and of the construction board (to be made) match.

In this way, a particularly high correspondence of requirements to be met can be achieved. In addition, a good prediction of the achievable properties of the construction board to be made can thus already be made. In addition, fewer adaptations are necessary and the method can be implemented in a particularly energy-saving manner.

In contrast, in other cases, it may in turn be advantageous if the preformed construction board is assigned to a construction-board type and the construction board (to be made) is assigned to another construction-board type and if the construction-board type of the preformed construction board and of the construction board (to be made) are different from one another.

As already described, a person skilled in the art, in the case of construction boards having at least one layer having a natural-based fiber portion, is fundamentally different between long-fiber boards, which are frequently also referred to as OSB boards, chipboards and fiberboards, which are then formed as MDF or HDF boards. If one and the same construction board has a first layer assigned to a first of the named types and a second layer to be assigned to a type different therefrom, a person skilled in the art generally refers to these construction boards as hybrid boards. If a plastic layer or a real wood layer forms the outer layer on one or both usable sides, a person skilled in the art, as already mentioned, refers to it as a laminated board (on one side or on both sides).

Although apparently contradictory, in the manufacturing process of a construction board associated with a particular type, however, a construction board of another type that has already been preformed (or was) to be supplied with a significant process advantage: The manufacture site or the manufacture site, respectively specifically, the factory must be designed only for the manufacture or manufacture of natural-based fiber portions intended for this particular construction-board type, while the starting material obtained from the preformed construction board can then be incorporated into the ongoing manufacture at a suitable point via a bypass.

In addition, a person skilled in the art differs from the origin of the natural-based fibers and, there, essentially, whether the fibers consist of annual or perennial plants were obtained. In the case of annual plants, these are mainly grasses, such as bamboo or straw as the basis, in the case of the perennial plants are different types of wood. With regard to this feature division, it may also be advantageous if the preformed construction board is assigned to one construction-board type and the construction board (to be made) is assigned to another construction-board type and if the construction-board type of the preformed construction board and the construction board (to be made) are identical or different from one another.

In many applications, it may be advantageous if at least 90%, in particular at least 95%, very particularly at least 99% of the raw material made from the preformed construction board in step i) is formed by particles of a mesh size of a maximum of 100 mm by a maximum of 100 mm, preferably a maximum of 60 mm by a maximum of 60 mm, most preferably a maximum of 50 mm by a maximum of 50 mm.

It is also very particularly advantageous if at least 90%, in particular at least 95%, very particularly at least 99% of the raw material made in step i) from the preformed construction board has nominal sizes, in the length and width direction, between about 30 mm×20 mm and 60 mm×80 mm, most preferably between 50 mm by 50 mm and 60 mm by 60 mm, the thickness of the raw material being substantially the same as that of the preformed construction board and thus being between 3 mm and 85 mm, in particular between 8 mm and 60 mm, very particularly between 8 mm and 30 mm.

Specifically, the inventors have recognized that the provision of a two-stage (comminuting) process of the raw material with the incorporation of a mechanical comminution step and the subsequent use of the pressure shock waves works particularly well if the pressure shock waves impinge on precomminuted bits of the preformed construction board that lie in the above-mentioned preferred ranges. This is surprisingly true in wide part irrespective of the thickness of the preformed construction board or parts obtained by process step i), which, however, should be in the cited strength ranges. Both extremes, that is to say both during the machining of very thin (low strength) preformed construction boards, and also during the machining of very thick (high strength) preformed construction boards, poorer results were obtained in experiments is achieved as in the middle strength regions.

At least the method step ii) for providing a volume fraction of 10% to 100%, preferably of 20% to 100%, very preferably of 35% to 100%, is particularly advantageous, very particularly preferably from 55% to 100% of the natural-based fiber fraction, in the form of the starting material, for the construction board to be made. In this case, it is preferred that the manufacture of the construction board is designed and operated in a continuous process with a manufacture speed of 800 mm to 3500 mm of construction board length per minute. The residence time of the starting material made from the raw material in method step ii) can advantageously be between 0.08 sec and 24 sec, particularly advantageously between 0.08 sec and 4.0 sec with a very particular advantage at between 0.08 sec and 1.6 sec.

Such a design of the method and, in particular, the corresponding adaptation of the method step ii) and the method steps succeeding it brings considerable economic advantages and thus finally enables the implementation an ecologically expedient overall concept with a high recycling proportion and low energy consumption.

It is advantageous if, for carrying out process step ii), a superatmospheric pressure region is provided, in which a pressure (absolute) between 15 bar and 75 bar prevails at least temporarily during operation and a vacuum region is further provided, in which a subatmospheric pressure (absolute) between 0.08 bar and 0.85 bar prevails at least temporarily during operation.

In this way, the mechanical properties of the natural-based fiber components obtained from the preformed construction boards and serving as the starting material for making a factory panel can be largely retained. In addition, economical manufacture is thus particularly possible with relatively very low energy expenditure.

It is of great advantage if the forming process portion comprises a material stream of the natural-based fiber portion, and the material stream passes through at least the following process steps:
a) Material preparation
b) Gluing
c) Shaping
d) Pressing
e) Fabrication
   and where the material stream between process step a) and process step e) experiences increasing curing in relation to the construction board to be made, so the degree of curing can be evaluated on the basis of at least one parameter.

In this way, it is particularly possible to make construction board. In this case, it is particularly preferred that the process steps are run continuously. Thus, method step c) is carried out using a continuously operating press. If the increasing degree of curing is monitored on the basis of a parameter, for example density, tensile strength or bending strength, automatic measures can be implemented in a particularly simple manner. In particular, the manufacture of uniformly high-quality construction board is thus achieved.

For this purpose, it can be provided that the method is linked to a control system and at least method steps i) and ii) are controlled using measured parameters where the measurements are carried out by sensors downstream, that is to say when a higher degree of curing is reached compared to the state of the construction board to be made during the execution of method step iii), and preferably also only after carrying out process step iv).

In this context, it may be of great advantage if at least one of the steps (i-v) provides input requests to the material stream (M), which are evaluated on the basis of at least one of the stated parameters. In this case, step e) can comprise a gluing.

It is also of great advantage if the component between process step i) and process step iv) suitable for the forming process portion of the construction board (in particular as a starting material), has a growing degree of curing relative to the component to be made and the supply of at least one component into the further manufacture process is carried out in coordination with the degree of curing of the material stream.

For example, it may be particularly preferred that the component supplied to the manufacturing process is modified with regard to at least one size, such as, for example, fiber type, fiber size, fiber quality as far as possible to the fibers already present in the forming process. In this case, a corresponding tolerance range can be defined and can likewise influence the already described control with or without feedback of the manufacture process.

Preferably, the method comprises at least one of the (further) process steps:
f) Fiberizing
g) Fractionation
h) Classification
j) Intermediate storage
k) Drying
l) Pressurization
m) Heat treatment
n) Grinding
o) Fabrication
p) Stacking (with cooling)
q) Curing storage and output storage

The process steps l) and m) can generally also be referred to as “energy supply” and in particular can be formed by a preferably continuously operating pressing operation so that they correspond to the previously described step c) and then do not have to occur repeatedly.

It is advantageous if at least one component is supplied at least proportionally to the auxiliary process portion.

There, the component can, for example, be thermally utilized and, in particular, serve for heat recovery for at least one of the process steps a) to m). This also contributes to an environmentally friendly manufacture process. In addition, it reduces both the cost of external energy and the disposal fees to be paid for nonuse in many states.

It is further advantageous if at least one component comprises a natural-based fiber portion that is in particular in the form of perennial plants, in particular of wood, formed cellulose-containing fibers and/or chips and/or long chips.

It may also be of great advantage if at least one component comprises a natural-based fiber portion and the natural-based fiber portion is in particular in the form of annual plants, in particular of straw or grass, formed cellulose-containing fibers and/or chips and/or long chips.

In this way, a particularly valuable proportion of the preformed construction board is used and further incorporated in the forming process of the method of making a construction board.

It is advantageous if the fibers and/or chips and/or long chips forming the natural-based fiber portion have a relative humidity and the relative humidity is present, in particular during, the performance of method step i) in a range between 2% and 30%, in particular between 2% and 18%, very particularly between 2% and 12%, and during the performance of method step ii) it is not greater than 66%, in particular not more than 50%, very particularly not more than 33% or even not more than 25% and very particularly preferably not more than 15%.

In this way, a high quality of the fibers and/or fiber components used as the starting materials can be obtained so as to ensure the manufacture of high-quality construction board. It may also be advantageous if the fibers and/or chips and/or long chips forming the natural-based fiber portion have a relative humidity and the relative humidity is present, in particular also during, the performance of method step i) in a range between 2% and 30%, in particular between 2% and 18%, very particularly between 2% and 12%, and during the execution of method step iii) it is not greater than 66%, in particular not more than 50%, very particularly not more than 33% or even not more than 25% and very particularly preferably not more than 15%.

This measure also contributes considerably to securing the retention of the high quality of the fibers and/or fiber components used as the starting material and thus makes it possible to make recycled construction boards in previously unknown quality.

Preferably, at least the component determined as a starting material and made in method step ii) is formed as a mixture of chips at least 80%, preferably at least 85%, preferably at least 92%, a width between 0.25 mm and 10.0 mm, preferably between 0.30 mm and 8.0 mm, a length between 0.25 mm and 60.0 mm, preferably between 0.30 mm and 50.0 mm, and a thickness between 0.15 mm and 1.8 mm, preferably between 0.15 mm and 0.75 mm. In this context, the word “generates” is to be understood in the sense of a release, freeing or also separation.

Preferably, at least the component (K1, K2) determined as the starting material (11) and made in method step ii), is formed as a mixture of long chips at least 80%, preferably at least 85%, preferably at least 92%, a width between 5.0 mm and 45.0 mm, preferably between 6.0 mm and 30.0 mm, a length between 60.0 mm and 185.0 mm, preferably between 70.0 mm and 160.0 mm, and a thickness between 0.15 mm and 2.5 mm, preferably between 0.3 mm and 2.0 mm.

It is also advantageous if at least the component (K1, K2) used as the starting material and made in method step ii) is formed as a mixture of fibers at least 80%, preferably at least 85%, very preferably at least 92%, a width between 0.05 mm and 2.0 mm, preferably between 0.2 mm and 0.9 mm, a length between 0.3 mm and 40.0 mm, preferably between 0.3 mm and 4.5 mm, and a thickness between 0.05 mm and 2.0 mm, preferably between 0.05 mm and 0.85 mm.

In these contexts, the word “generates” is to be understood in the sense of a release, freeing or also separation. Surprisingly, it has been found that chips, long chips and fibers of the respective size ranges mentioned for this purpose, on the one hand, can be separated particularly well from their original composite (from the preformed construction board) and, on the other hand, can also be introduced particularly well into the forming process.

In an apparatus for making a construction board having at least one layer having at least one natural-based fiber portion, where at least one layer is comprised of a starting material, the object of the invention is achieved in that the apparatus is designed to have at least one forming process portion and an auxiliary process portion, and the apparatus comprises at least the following:
I) a device for the mechanical precomminuting of the preformed construction board into raw material,
II) a device for breaking down the raw material under the action of a pressure shock wave having a pulse duration and a pulse frequency into at least one first component and at least one second component, where at least one of the components is suitable as the starting material for use in at least one forming process portion of the construction board,
III) means for separating at least the second component and the first component
IV) means for at least partially feeding the at least one component suitable for the forming process portion of the construction board into the forming process portion of the further manufacture process.

It is thus possible to use preformed construction boards for high-quality manufacture ecologically and economically and to be able to make recycled construction boards in previously unknown quality.

It is particularly advantageous if the device comprises at least one of the further devices:
Fiberizing device,
Fractionizer
Classifier
Intermediate storage
Dryer
Pressurizing device
First heat-treatment device
Grinding device
Assembly device
Stacking device
Second heat-treatment device, in particular cooler
and/or
curing storage with output storage

In this case, the individual devices for achieving the manufacture of high-quality construction boards consisting at least partially of a starting material made from a preformed construction board contribute to improving the economic and ecologically expedient implementation possibilities of a device formed on such a device.

Furthermore, it is of great advantage if the device for at least partially feeding the at least one component suitable for the forming process portion of the construction board into the forming process portion is formed in such a way that the suitable component can be introduced upstream of and/or into at least one of the following devices, preferably adapted to the degree of curing which can be reached there:
Separator (130)
Fractionizer (160)
Classifier (170)
Intermediate storage (180)
Dryer (190)
Pressurizer (200)
Heat-treatment device (210)

In addition, it is particularly advantageous if the apparatus is designed to carry out a method according to at least one of claims 1 to 12.

The resulting advantages can be gathered by a person skilled in the art analogously to the corresponding advantage description of the method and its preferred design features and, if necessary, in a simple manner to a corresponding one. Apparatus design can be adapted so that they are not to be unnecessarily repeated at this point.

In a construction board having at least one layer having at least one natural-based fiber portion, where at least one layer is comprised of a material, the object of the invention is achieved in that the starting material a pressure shock wave having a pulse duration and a pulse frequency is used to make at least one first component and a second component, at least one of the components being used as the starting material for use in at least one forming process component of the construction board to be made and the effect of the pressure shock wave is mechanical precomminution.

In this way, it is possible to provide a recycled construction board in a previously unknown quality. In addition, it is possible in this way to manufacture a construction board with good mechanical properties and attractive optical properties, good processability and good compatibility for the human organism under environmentally friendly conditions in a cost-effective manner.

It is also particularly advantageous if the construction board is made according to a method according to one of claims 1 to 12.

The resulting advantages can be gathered by a person skilled in the art analogously to the corresponding advantage description of the method and its preferred design features and, if necessary, in a simple manner to a corresponding one. Construction board design can be adapted so that it is not to be unnecessarily repeated at this point.

Finally, the object of the present invention is achieved in the use of a construction board for residential construction or furniture construction in that a construction board according to one of claim 17 or 18 is used.

The resulting advantages can also be gathered by a person skilled in the art analogously to the corresponding advantage description of the method and its preferred design features and, if necessary, in a simple manner to a corresponding one. The use of a construction board can be adapted so that they are not to be unnecessarily repeated at this point.

The invention is explained in more detail below on the basis of a drawing illustrating only one embodiment. Therein:

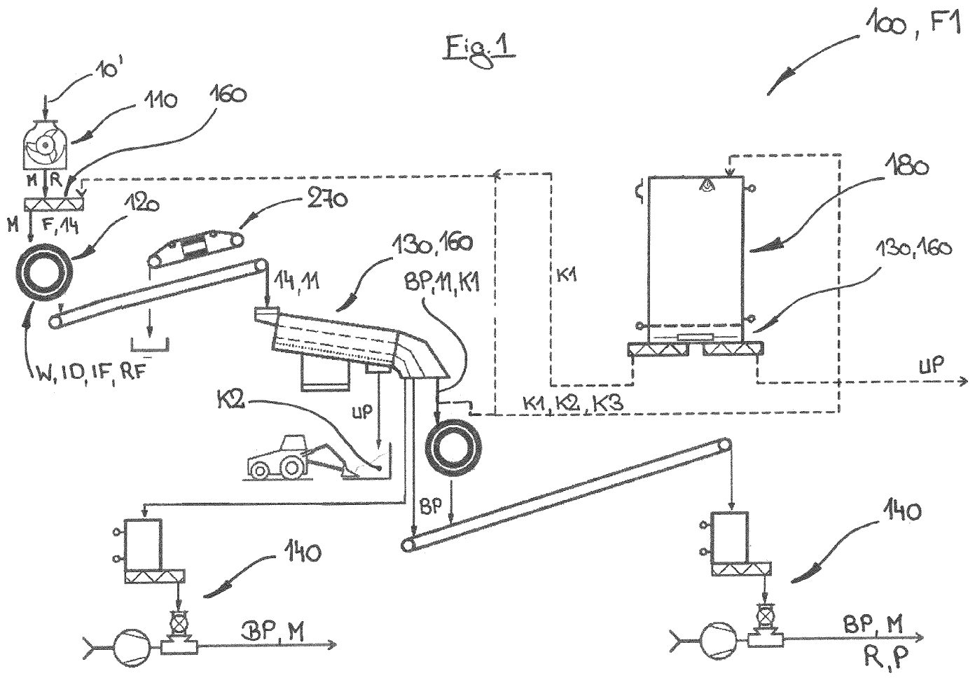

FIG. 1 is a schematic flow diagram of the apparatus 100 for carrying out process steps i) to iv),

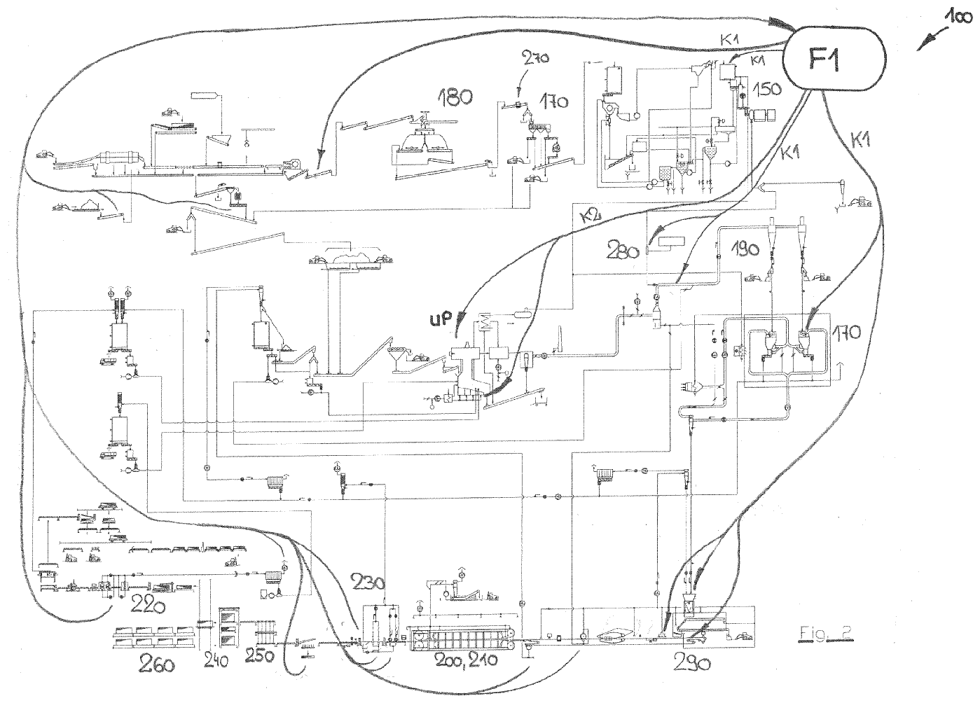

FIG. 2 is a schematic flow diagram of the apparatus 100 set up for making construction boards having MDF and/or FIDF layers, or hybrid boards formed therefrom,

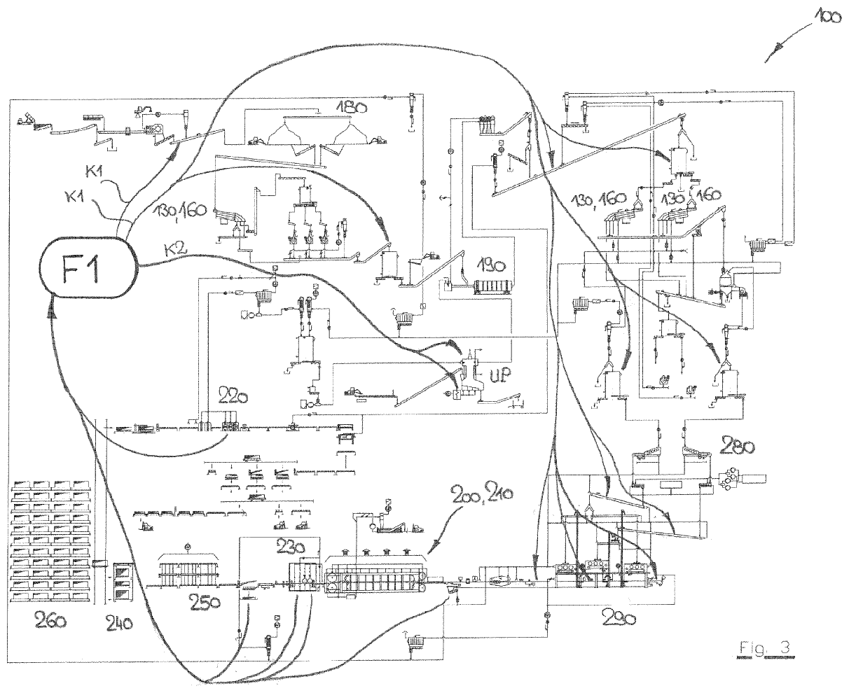

FIG. 3 is a schematic flow diagram of the apparatus 100 set up for making construction boards having a chip layer, or hybrid boards formed therefrom,

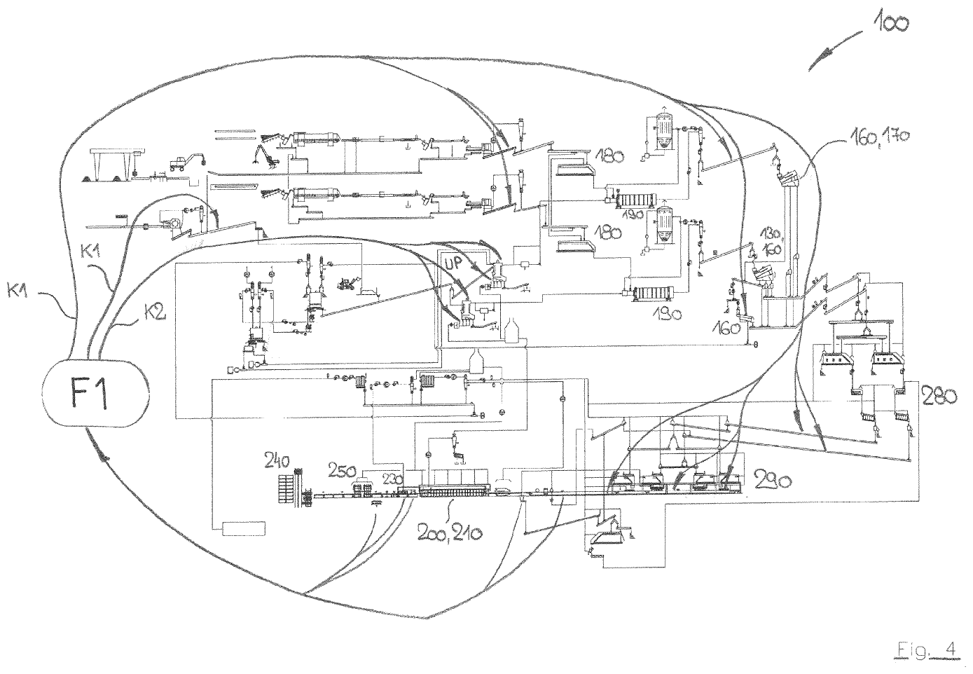

FIG. 4 is a schematic flow diagram of the apparatus 100 in the form of construction boards set up for making a long-span layer (OSB layer), or hybrid boards formed therefrom,

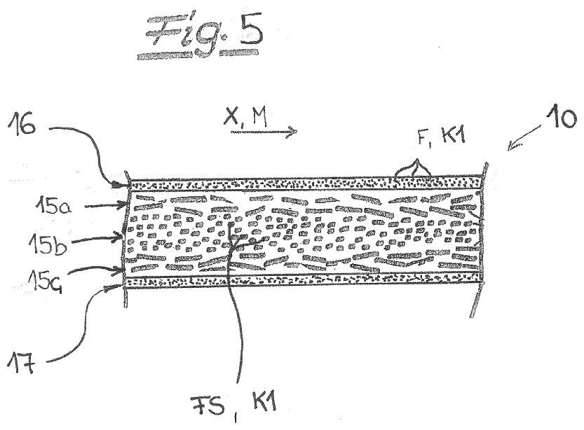

FIG. 5 is a section through a construction board.

FIG. 1 shows an apparatus 100 for making a construction board 10 having at least one layer 15, 16, 17 having at least one natural-based fiber portion F and illustrated in a schematic manner in FIG. 5 where at least one of the layers 15, 16, 17 is comprised of a starting material 11 made from a raw material 14 obtained from a preformed construction board 10′, and the apparatus 100 is configured with at least one forming process portion BP and an auxiliary process portion UP, and the apparatus 100 comprises at least the following:
I) a device 110 for mechanical precomminuting the preformed construction board 10′ in raw material 14,
II) a device 120 for breaking down the raw material 14 under the action of a pressure shock wave W having a pulse duration ID and a pulse frequency IF into at least one first component K1 and at least one second component K2, where at least one of the components K1, K2 is suitable for use as the starting material 11 used in at least one forming process component BP of the construction board 10,
III) a device 130 for separating at least the second component K2 and the first component K1, and
IV) a device 140 for at least partially feeding at least one component K1, K2 suitable for the forming process component PB of the construction board 10 into the forming process portion PB of the further manufacture process.

The illustrated apparatus 100 is used to carry out a method of making a construction board 10 having at least one layer 15, 16, 17 having at least one natural-based fiber portion F, where at least one layer 15, 16, 17 is comprised of a starting material 11 made from a raw material 14 obtained from a preformed construction board 10′, and the method comprises at least one forming process portion BP and an auxiliary process portion UP and comprises at least the following steps:
i) mechanical precomminuting the preformed work construction board 10′ in raw material 14,
ii) breaking down of the raw material under the action of a pressure shock wave W having a pulse duration ID and a pulse frequency IF into at least one first component K1 and a second component K2, where at least one of the components K1, K2 is suitable as the starting material 11 for use in at least one forming process component BP of the construction board 10 to be made,
iii) separating at least the second component K2 and the first component K1, and
iv) at least partially feeding at least one component K1, K2 suitable for the forming process component BP of the construction board 10 into the forming process component BP of the further manufacture process.

Such a method that can be advantageously developed by way of example according to one of the embodiments illustrated in FIGS. 2 to 4 can make a construction board 10 having at least one layer 15, 16, 17 having a natural-based fiber portion F, where at least one of the layers 15, 16, 17 is comprised of a starting material 11, in that, raw material 14 can be made in which the starting material 11 is divided into at least one first component K1 and a second component K2 under the action of a pressure shock wave W having a pulse duration ID and a pulse frequency IF, and at least one of the components K1, K2 is used as the starting material 11 for use in at least one forming process component BP of the construction board 10 to be made and is mechanically precomminuted by the action of the pressure shock wave W. Such construction boards can be used particularly well for residential construction, in particular for indoor use or furniture construction.

For this purpose, the apparatus 100 shown in FIG. 1 provides, in the left upper image edge, first a device 110 for mechanically precomminuting the preformed construction board 10′ into the raw material 14 formed here by way of example in the form of a hammer mill. In principle, however, a rotor chopper or also a saw could also be provided here.

The raw material 14 made in this way can then be fed through a fractionizing device 160 that here serves as a simple screen arrangement and that ensures, for example, that at least 90%, in particular at least 95%, very particularly at least 99% of the raw material made from the preformed construction board by the apparatus 100 with the mesh sizes of a maximum of 100 mm by a maximum of 100 mm, preferably a maximum of 60 mm by a maximum of 60 mm, very preferably a maximum of 50 mm by a maximum of 50 mm, to the adjoining device 120.

The fractionizer (here: screen arrangement) 160 can also be designed in such a way that at least 90%, in particular at least 95%, in particular at least 99% of the raw material made in step i) from the preformed construction board, nominal sizes, in length and width direction, between approximately 30 mm×20 mm and 60 mm×80 mm, preferably between 50 mm by 50 mm and 60 mm by 60 mm, and the thickness of the raw material can be substantially the same as that of the preformed construction board and is thus preferably between 3 mm for carrying out the method and 85 mm, in particular between 8 mm and 60 mm, very particularly between 8 mm and 30 mm.

The raw material 14 is then divided in the device 120 into at least the first component K1 and at least the second component K2 under the effect of the pulse duration ID and the pulse frequency IF, for example, and at least one of the components K1, K2 is suitable as the starting material 11 for use in at least the forming process component BP of the construction board 10. For this purpose, the material made from the raw material remains within the effective range of the device 120 provided for carrying out method step ii) advantageously between 0.08 sec and 24 sec, particularly advantageously between 0.08 sec and 4.0 sec, with very particular advantage between 0.08 sec and 1.6 sec, the first component K1 and the second component K2 being already separated from one another in the device 120. If the preformed construction board 10′ contains further components, for example K3, K4, K5, these components can also be separated from one another in the device 120.

However, the separated components K1 and K2, as well as optionally K3, K4 and K5 or further, can still be transported further at least partially in a common material stream after their separation, without having to be bound to one another. In this case, the paths of the forming process portion and of the auxiliary process portion can first lie one above the other, that is to say use the same devices. A selection of the individual components then is done by the device 130 for separating at least the second component K2 and the first component K1, even if it, as in the present example, is upstream of a preselector 270 for sorting out iron-containing components. Iron-containing parts consisting for example of fasteners remaining in the preformed construction board, such as screws, nails, fittings, hinges or the like are neither in the forming process portion nor in the auxiliary process portion and are advantageously diverted to an off-site recycling process.

Through the selection carried out with the aid of the device 130 and the separation of at least the second component K2 and the first component K1, the process paths of the forming process component BP and of the auxiliary process portion UP following the device 130 at least for a portion of the entire material stream separately from one another.

In the present embodiment, in addition to the process path of the forming process portion BP and the process path of the auxiliary process portion UP, the device 130 provides an additional path provided for components not yet completely separate from one another and can be fed back to the device 120 via a loop and, if appropriate, with the interposition of intermediate storage 180. In this case, a further fractionizer 160′ can be operatively connected to the intermediate storage and ensure that the device 120 is only supplied with suitable component impurities or only suitable raw material 14, while the selected-out raw material is, for example, fed once again to the device 110 for mechanical precomminuting the preformed construction board 10′, a comparable device or the auxiliary process portion, for example for thermal purposes.

When carrying out these method steps, it is furthermore possible and preferred to configure the method of making a construction board in such a way that the fibers FF and/or chips FS and/or long chips FL forming the natural-based fiber portion F have a relative humidity R and the relative humidity present in particular also during process step i) is in a range between 2% and 30%, in particular between 2% and 18%, very particularly between 2% and 12%, and during method step ii) and additionally preferably also in method step iii) does not rise to more than 66%, in particular not more than 50%, very particularly not more than 33% or even not more than 25% and very particularly preferably not more than 15%, which has an especially economical and ecologically valuable effect on the forming process component.

The apparatus 100 described in FIG. 1 and the process sequences thereof are each also a component of the devices described in FIGS. 2 to 4. In order to avoid repetitions and for reasons of clarity, the apparatus 100 shown in FIG. 1 or the portion of the apparatus 100 of the following figures shown in FIG. 1 is symbolically indicated by a black box F1 also connected in terms of process to the remaining portions of the embodiments of the apparatus 100 that differ between FIGS. 2 to 4.

The devices 100 shown there differ in their design features provided for the manufacture of construction boards of a particular type.

The apparatus 100 shown in FIG. 2 is designed to make construction boards 10 having at least one MDF layer or at least one FIDF layer. With the aid of an apparatus 100 designed in this way, MDF boards or FIDF boards can thus be made. Also, with the aid of the apparatus 100, it is also possible to make hybrid boards having at least one, have a layer formed according to an MDF or HDF type. For this purpose, further units can be connected to or integrated into the illustrated device.

A laminator at least one of the surface-forming construction board sides in the manufacture process can be directly or indirectly connected to the illustrated apparatus 100, or can be integrated in the illustrated manufacture process at a suitable location.

The forming process component BP forming within the apparatus 100 in connection with the implementation of the described method of making a construction board 10 comprises a material stream M of the natural-based fiber portion F, where the material stream M shown in FIGS. 2 to 4 runs at the top left clockwise to the bottom left and passes through at least the following process steps:
a) Material preparation
b) Gluing
c) Shaping
d) Pressing
e) Fabrication
   and wherein the material stream M between process step a) and process step e) experiences a growing degree of curing R in relation to the construction board 10 to be made, and the degree of curing R can be evaluated on the basis of at least one parameter P.

The component K1, K2 suitable for the forming process portion PB of the construction board is now fed between the process step i) and the process step iv) to the forming process BP, and the forming process proportion between these process steps experiences a growing degree of curing R′ relative to the construction board 10 to be made and the supply of at least one component K1, K2 is made in the further manufacture process in coordination with the degree of curing R of the material stream M. In FIG. 2, for this purpose the forming process portion BP of the method of making a construction board 10 comprises at least one of the further process steps:
f) Fiberizing
g) Fractionation
h) Classification
j) Intermediate storage
k) Drying
L) Pressurization
m) Heat treatment
n) Grinding
o) Fabrication
p) Stacking (with cooling)
q) Curing storage and output storage
   and the degree of curing of the construction board 10 to be made increases further in accordance with the sequence of the process steps provided therefrom along the material stream M. According to the invention, at least one of the further devices is accordingly implemented:

Defibering device 150, fractionizer 160, classifier 170, intermediate storage 180, dryer 190, pressurizer 200, first heat-treatment device 210, Grinding device 220, fabrication device 230, stacking device 240, second heat-treatment device, in particular cooler 250 and/or curing storage with output storage 260.

In the example shown, the device 140 designed for at least partially supplying at least one supply of at least one component K1, K2 suitable for the construction board 10 is formed in the forming process portion PB in such a way that the suitable component is present upstream and/or in at least one of the following devices, preferably adapted to the degree of curing R that can be reached there:
Separator 130
Fractionizer 160
Classifier 170
Intermediate storage 180
Dryer 190
Pressurizer 200
Heat-treatment device 210

In this case, at least the component K1, K2 determined as the starting material 11 and made in method step ii) is formed as a mixture of fibers at least 80%, preferably at least 85%, very preferably at least 92%, a width between 0.05 mm and 2.0 mm, preferably between 0.2 mm and 0.9 mm, a length between 0.3 mm and 40.0 mm, preferably between 0.3 mm and 4.5 mm, and a thickness between 0.05 mm and 2.0 mm, preferably between 0.05 mm and 0.85 mm.

It is also provided in the embodiment according to FIG. 2 that at least one component K1, K2 is supplied at least proportionally to the auxiliary process portion UP. This is preferably a component that appears to be suitable only slightly for use in the forming process component and/or the further preparation thereof is not appropriate for ecological and/or economic reasons. Since use in the auxiliary process portion UP, for example in the recovery of thermal energy, requires the need for foreign bodies, energy usage, for example of liquid or gaseous fuels, are lowered and, at the same time, removal from the region of the device for making a construction board is unnecessary and ecological and economic advantages result.

On the other hand, at least at least one component K1, K2 provided for the forming process portion comprises a natural-based fiber portion F, and the natural-based fiber portion F is in particular in the form of annual plants or cellulose—containing fibers FF obtained in particular from wood. If a construction board of a hybrid type is to be made with the aid of the apparatus 100, the construction board provided for the forming process portion can be provided, and at least one component K1, K2 (also) has a natural-based fiber fraction F formed in the form of chips FS and/or long chips FL containing cellulose obtained from annual plants, in particular from wood.

Alternatively, however, at least at least one component K1, K2 provided for the forming process portion has a natural-based fiber portion F that is formed in particular in the form of cellulose-containing fibers FF obtained from annual plants, in particular from straw or grass. If a construction board of a hybrid type is to be made with the aid of the apparatus 100, at least one component K1, K2 (also) provided for the forming process portion can have a natural-based fiber portion F in the form of chips FS and/or long chips FL containing cellulose obtained from annual plants, in particular from straw or grass.

The apparatus 100 shown in FIG. 3 is designed to make construction boards 10 having at least one chip layer. With the aid of an apparatus 100 designed in this way, chip boards can thus be made. Also, with the aid of the apparatus 100, it is also possible to make hybrid boards having at least one layer formed according to chip type. A lamination on at least one of the surface-forming construction board sides in the manufacture process can be directly or indirectly connected to the illustrated apparatus 100, or can be integrated in the illustrated manufacture process at a suitable location.

In this case, at least the component (K1, K2) determined as the starting material 11 and made in method step ii) is formed as a mixture of chips at least 80%, preferably at least 85%, preferably at least 92%, a width between 0.25 mm and 10.0 mm, preferably between 0.30 mm and 8.0 mm, a length between 0.25 mm and 60.0 mm, preferably between 0.30 mm and 50.0 mm, and a thickness between 0.15 mm and 1.8 mm, preferably between 0.15 mm and 0.75 mm. The apparatus 100 shown in FIG. 4 is designed to make construction boards 10 having at least one long chip layer (OSB layer). With the aid of an apparatus 100 designed in this way, long-span boards (OSB boards) can thus be made. Also, with the aid of the apparatus 100, it is also possible to make hybrid boards having at least one layer formed according to a long-span type. A lamination of at least one of the surface-forming construction board sides in the manufacture process can be applied in the illustrated apparatus 100 or can be integrated at a suitable point in the manufacturing process shown.

In this case, the device 140 is designed for at least partially supplying the starting material 11 obtained in the device component F1 in such a way that, at least one component K1, K2 suitable for the forming process portion PB of the construction board 10 is formed in the forming process portion PB in order to at least partially supply at least one component K1, K2 suitable for the forming process portion PB, so that the suitable component can be introduced upstream and/or into at least one of the following devices, preferably adapted to the degree of curing R that can be reached there:
Separator 130
Fractionizer 160
Classifier 170
Intermediate storage 180
Dryer 190
Pressurizer 200
Heat-treatment device 210

In the illustrated example, as in FIGS. 2 and 4, the component K1 for the forming process portion BP and the component K2 are provided for the auxiliary process portion UP. Of course, it is also conceivable that in F1 both components K1 and K2 or else further components for the forming process portion are prepared and selected and another component, for example K3 or K5 for use in the auxiliary process portion UP, or even to be removed from the factory site of the apparatus 100.

In this case, at least the component K1, K2 determined as the starting material 11 and made in method step ii) is thus formed only as a mixture of long chips at least 80%, preferably at least 85%, preferably at least 92%, a width between 5.0 mm and 45.0 mm, preferably between 6.0 mm and 30.0 mm, a length between 60.0 mm and 185.0 mm, preferably between 70.0 mm and 160.0 mm, and a thickness between 0.15 mm and 2.5 mm, preferably between 0.3 mm and 2.0 mm.

FIG. 5 shows a construction board 10. It has at least one layer 15, 16, 17 having at least one natural-based fiber portion F, and at least one layer 15, 16, 17 is the starting material 11 made from a raw material 14 obtained from a preformed construction board 10′, and this starting material 11 is made under the action of pressure shock wave W having a pulse duration ID and a pulse frequency IF into at least one first component K1 and a second component K2, and at least one of the components K1, K2 is used as the starting material 11 for use in at least one forming process component BP of the construction board 10 to be made and is mechanically precomminuted prior to the action of the pressure shock wave W.

The construction board 10 shown in FIG. 5 is preferably made by a described apparatus 100 for making a construction board and by carrying out a described method of making a construction board 10.

The illustrated construction board 10 is then preferably used for inside residential construction and/or for furniture construction.

Such a (wood) construction board 10 has a core or core layer 15 as well as a for example upper first outer layer 16 and a for example lower second outer layer 17, the mixtures of the fibers or particles, for example chips, of the two outer layers 16, 17 comprise at least 30%, preferably at least 50%, very preferably at least 70%, of natural-based fibers which were already a component of a preformed construction board 10′ and were made by the action of a pressure shock wave W having a pulse duration ID and a pulse frequency IF from the preformed construction board 10′.

In the illustrated embodiment, the core layer 15 itself is in turn formed of multiple layers. It has an upper layer 15a, a middle layer 15b and a lower layer 15c each here consisting of longer chips but with different orientations. While the longer chips of the upper outer layer 15a and the lower outer layer 15c extend in the manufacturing direction X (parallel to the material stream M) or the board longitudinal direction X, the chips FS of the middle layer 15b derived, for example, as first component K1 from a preformed construction board 10′, are substantially transverse to one another.

The manufacture direction X or construction board longitudinal direction, extend in the Y direction. This is merely indicated in simplified form in FIG. 5. However, the core can also be formed in one layer and/or in the form of another layer type, for example as a long chip layer type (OSB) or as an MDF/HDF layer type. Of course, many other designs of the construction board are also possible. Thus, the construction board 10 shown here has been made with the aid of an apparatus 100 formed in accordance with FIG. 2 and has at least one layer 15, 16, 17 formed according the chip type and has chips FS as component K1. For the sake of clarity, further representations of construction boards 10, which are constructed analogously and are made with the aid of an apparatus 100 formed in accordance with FIG. 3 or according to FIG. 4, are dispensed with.

The remaining fiber fraction, that is to say the fibers that are not obtained from a preformed construction board 10′, can be homogeneously mixed with the described proportions in order to form the individual layers, or can be used in a targeted manner to form a single layer or intermediate layer.

LIST OF REFERENCE SIGNS

| | |
|---|---|
| 10 Construction board | 190 Dryer |
| 10′ (at least partially) | 200 Pressurizing device |
| preformed construction board | |
| 11 Starting material | 210 First heat-treatment device |
| 14 Raw material | 220 Grinding device |
| 15 Layer | 230 Assembly device |
| 16 Layer | 240 Stacking device |
| 17 Layer | 250 Second heat-treatment device, |
| | in particular cooler |
| 100 Device (also: plant) | 260 Curing storage with output storage |
| 110 Device for mechanical | 270 Preselecting device |
| precomminution | |
| 120 Device for the breaking | 280 Gluing device |
| down raw material | |
| 130 Separator | 290 Shaping device, scattering |
| | BP-forming process portion |
| 140 Device for at least | F Fiber fraction |
| two-part supply | |
| 150 Fiberizing device | F1 device (- component) according to |
| | FIG. 1 |
| 160 Fractionizer | FF Fibers |
| 170 Classifier | FL Long chips |
| 180 Intermediate storage | FS Chips |
| ID Pulse duration | RF Relative humidity |
| IF Pulse frequency | UP Auxiliary process portion |
| K1 Component | W Pressure shock wave |
| K2 Component | X Spatial direction, longitudinal |
| | direction |
| K3 Component | Y spatial direction, transverse |
| | direction |
| K4 Component | Z Height direction |
| K5 Component | |
| M Material stream | |
| P Parameter | |
| R Degree of curing | |

1. A method of making a construction board having at least one layer having at least one natural-based fiber portion, the at least one layer being comprised of a starting material made from a raw material obtained from an at least partially preformed construction board, the method having at least one forming process portion and an auxiliary process portion, the method comprising at least the following steps:
i) mechanically precomminuting the preformed construction board into the raw material,
ii) breaking down the raw material under the action of a pressure shock wave having a pulse duration and a pulse frequency into at least one first component and a second component, at least one of the components being suitable as the starting material for use in at least the forming process portion of the construction board to be made,
iii) separating at least the second component and the first component, and
iv) at least proportional supply of the at least one component suitable for the forming process component of the construction board into the forming process portion of the further forming process.

2. The method according to claim 1, wherein
the forming process portion comprises making a material stream of the natural-based fiber portion and passing the material stream through at least the following process steps:
a) Material preparation,
b) Gluing,
c) Shaping,
d) Pressing, and
e) Fabrication,
the material stream between process step a) and process step e) experiencing a growing degree of curing in relation to the construction board to be made, the degree of curing being evaluated on the basis of at least one parameter.

3. The method according to claim 1, wherein the component suitable for the forming process portion of the construction board between process step i) and process step iv) cures to a growing degree in relation to the construction board to be made, the method further comprising the step of:
feeding the at least one component into the further manufacture process in coordination with the degree of curing of the material stream.

4. The method according to claim 1, wherein the method comprises at least one of the further process steps:
f) Defibering,
g) Fractionation,
h) Classification,
j) intermediate storage,
k) Drying,
l) Pressurization,
m) Heat treatment,
n) Grinding,
o) Fabrication,
p) Stacking, or
q) Curing storage and output storage,

5. The method according to claim 1, further comprising the step of:
feeding the at least one component at least proportionally to the auxiliary process portion.

6. The method according to claim 1, wherein
the at least one component comprises a natural-based fiber portion that is in particular in the form of particles of perennial plants.

7. The method according to claim 1, wherein the at least one component comprises a natural-based fiber portion particles of annual plant.

8. The method according to claim 1, wherein particles forming the natural-based fiber portion have a relative humidity and step i) is carried out such that the relative humidity is in a range between 2% and 30%, in particular between 2% and 18%.

9. The method according to claim 1, wherein particles forming the natural-based fiber portion have a relative humidity and step i) is carried out such that the relative humidity is in a range between 2% and 30%, in particular between 2% and 18%.

10. The method according to claim 1, wherein the starting material made in step ii) is a mixture chips at least 80% of chips each having a width between 0.25 mm and 10.0 mm and a length between 0.25 mm and 60.0 mm.

11. The method according to claim 1, wherein the starting material made in step ii) is a mixture long at least 80% of long chips each having a width between 5.0 mm and 45.0 mm and a length between 60.0 mm and 185.0 mm.

12. The method according to claim 1, wherein the starting material made in step ii) is formed as a mixture at least 80% of fibers each having a width between 0.05 mm and 2.0 mm and a length between 0.3 mm and 40.0 mm.

13. An apparatus for making a construction board having at least one layer having at least one natural-based fiber portion and comprised of a starting material made from a raw material obtained from an at least partially preformed construction board, wherein the apparatus carrying out a forming process portion and an auxiliary process portion the apparatus comprising:
I) a device for mechanically precomminuting the preformed construction board into a raw material,
II) a device for breaking down the raw material into at least one first component and at least one second component with at least one pressure shock wave having a pulse duration and a pulse frequency, at least one of the components being suitable as the starting material for use in the forming process portion
III) a device for separating at least the second component and the first component, and
IV) means for at least partially supplying at least one of the components to for the forming process portion of the construction board.

14. The apparatus according to claim 13, further comprising:
defibering means, fractionation means, classifying means, intermediate storage means, drying means, pressurizing means, first heat-treatment device, grinding device, fabrication device, stacking device, second heat treatment device, in particular cooler or curing storage with output storage.

15. The apparatus according to claim 13, wherein the device for at least partially feeding the one component into the forming process portion is formed in such a way that the one component is introduced upstream of and/or into at least one of the following devices there:
Device for separating,
Fractionizer,
Classifier,
Intermediate storage,
Dryer,
Pressurizer, or
Heat-treatment device.

16. The apparatus according to claim 15, wherein the apparatus is designed to carry out a method according to claim 1.

17. A construction board having at least one layer having at least one natural-based fiber portion and comprised of a starting material obtained from a raw material made from an at least partially preformed construction board, wherein
the starting material is broken down into at least one first component and a second component under the action of a pressure shock wave having a pulse duration and a pulse frequency, and at least one of the components is used as the starting material for use in the forming process portion of the construction board to be made and is mechanically precomminuted by the action of the pressure shock wave.

18. The construction board according to claim 17, wherein the construction board is made according to a method according to claim 1.

19. Use of a construction board for residential construction or furniture construction, wherein the construction board is made according to claim 18.
